(19) United States
(12) Patent Application Publication
(10) Pub. No.: US 2003/0033467 A1
(43) Pub. Date: Feb. 13, 2003

(54) Method and apparatus for resource allocation in network router and switch

(76) Inventors: Satoshi Yoshizawa, Saratoga, CA (US); Daisuke Matsubara, Santa Clara, CA (US); Kenichi Otsuki, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/925,182

(22) Filed: Aug. 8, 2001

(51) Int. Cl. G06F 13/14

(52) U.S. Cl. 710/305

(57) ABSTRACT

A router system for dynamically allocating resources to enable provision of different levels of service in a network is described. The router includes a flow control table which stores entries that include source and destination addresses and priority information for each address. The priority information enables the provision of multiple different priorities to provide different qualities of service to different users of the network.

### BACKGROUND OF THE INVENTION

This invention relates to router systems for controlling traffic in a network, and in particular to a router system in which different priorities of service may be assigned in a flexible manner to different information in the network.

The advent of the internet has made communications networks, and their use throughout the world, commonplace. These communications networks now carry data, voice and video, necessitating ever greater bandwidths and imposing additional constraints on the quality of service provided.

The technology for internet protocol network systems (herein “IP”) is a relatively recently developed communications technology designed to overcome constraints associated with traditional networks. IP technology can be used to transmit data, voice and video, as well as any other type of data, on almost any type of network. Before the advent of IP, most networks were based on the type of data to be transported. For example, public switched telephone networks and high speed digital transmission facilities were primarily designed and used for transporting information sensitive to delay, such as voice or video. In contrast, many packet-based networks were developed for data information which could tolerate delay. Users then adopted network technology to provide the necessary capability for their particular application, but the result was that many organizations supported multiple different types of networks.

Conventional IP network systems employ packets of data, each containing many bytes. The packets can be transported and switched at relatively high rates, for example, hundreds of megabits per second. Each IP packet includes a header portion, typically of 20 bytes (in version 4), and a “payload” portion of arbitrary length, but less than a maximum length. The packet switching employed in such networks forwards a particular packet arriving on an input line to a desired output line, or to a desired address, based on the contents of a header in the packet. To achieve this, the system examines the header of the packet to determine the desired address to which that packet is to be forwarded, then the system sends the packet on toward its destination. If fixed-length packets are used, for example in an ATM system, relatively simple hardware can perform switching.

The header of an IP packet provides data for many different functions, including virtual path identification, virtual channel identification, payload type, error control, and other features. The use of packets enables packets transporting data, voice and video to be intermixed. Thus, variations in packet type may impact the latency of other packet types.

An IP device, commonly known as a router, is usually connected to receive information over many different incoming lines, and switch that information to many different outgoing lines. As a result, the IP packets arriving at the router are mixed with each other, that is, packets from each line are intermixed with packets from other lines. Packets from the individual connections, however, will be forwarded from router to router in accordance with their headers. In conventional routers, individual packets are routed from an input line to an output line depending on the information held in the packet header.

Network management includes the concept of quality of service resource allocation, for example, bandwidth and delay. Because of the different types of data and the different desired delivery characteristics, networks have adopted a variety of techniques for allocating quality of service resources. For example, it is important that voice data be delivered rapidly, as even a delay of a few fractions of a second will be noticeable. In contrast, a delay in the delivery of an email message of a few seconds, or even a few minutes, is not noticeable to a typical user. In addition, the increasing use of networks for transportation of voice and video data makes the allocation of quality of service more and more important.

In a typical network, the quality of service allocation mechanism, typically carried out of the network management system, is a relatively static operation. For example, in a typical network management system employing a computer coupled to control a network, the quality of service is set for preset times and preset durations well in advance of the demand for those resources.

With the advent of voice over IP technology, the quality of service allocation mechanism must handle more dynamic configurations than ever before. Network resources must be more frequently allocated and released, because the voice over IP or video-phone over IP may be used for a conversation without any preset starting time or preset duration. This is in contrast to a prearranged video or audio conference in which resources are reserved for a predetermined period. Furthermore, the use of multimedia data, for example the use of banner ads with video, is increasing. In view of the nature of the use of the internet, the quality of service allocation mechanism must be able to handle transactions which are very short lived, but which are invoked at a high frequency, for example, web browsing in which the number of transactions per unit time can be large.

There have been three typical prior art approaches to the control of quality of service in networks. In the “differentiated services approach,” a field known as the “differentiated services code point field” (DSCP), in the header of the packet is used to map each packet to a particular transmission priority at the network device. The mapping between the DSCP value and the transmission priority usually is set by the network management system and remains basically unchanged. The allocation is independent of a particular end-to-end transmission. The framework treats aggregates of flows, consisting of packets with the same DCSP value, differently from those aggregates of flows with different DCSP values. The transmission parameters are established prior to the start of the transmission and remain unaltered until the end of the transmission. In the framework of this system, changes of mapping during transmissions are not taken into account. This approach is described in more detail in IETF, “An Architecture for Differentiated Services,” RFC2475 (December 1998).

A second approach is commonly known as “active networks.” In this approach, every packet carries with it a program (or a reference, such as file name or pointer to a program) that is executed at the network device when the packet reaches that device. By writing a program to control the quality of service behavior at the network node, the quality of service of the flow of the packets can be controlled. A significant disadvantage of active networks is that encapsulation of the program into the packet limits the amount of payload information it can carry. Furthermore, although it is flexible in the sense of permitting control of the quality of service settings on a packet-by-packet basis, it is necessary that software executes at each network device, limiting the performance of the overall network transmission system. DARPA implements this approach to, for example, packet control. It is described further in Tennenhouse, D. L., et al., “Towards an Active Network Architecture,” SPIE Computer Communication Review, Vol. 26, No. 2 (1996); and Tennenhouse, D. L., et al., “A Survey of Active Network Research,” IEEE Communications Magazine (January 1997), pp. 80-86.

A third approach to control quality of service is known as “programmable networks.” In “programmable networks,” resources of the network devices are abstracted and made controllable by software. The software interacts with the network devices through a set of standardized application programming interfaces. By extracting resources related to the quality of service, such as those of queues, and making them available to be controlled through the APIs, one can manipulate the quality of service settings from the controller software. In addition, the standardized APIs permit easier and faster development of new network services. A disadvantage of the programmable networks approach is that it does not take into account the effect of controlling resources in a real time manner. Its scope is limited to static control, in the same manner as the differentiated services approach described above. The programmable networks concept is described in Lazar, A., “Programming Telecommunication Networks,” IEEE Network (September/October 1997), pp. 8-18; and Biswas, J., et al., “The IEEE P1520 Standards Initiative for Programmable Network Interfaces,” IEEE Communications, Special Issue on Programmable Networks, Vol. 36, No. 10 (October 1998).

### SUMMARY OF THE INVENTION

This invention provides two phases for allocating quality of service in a network system. In the first phase a conventional method of allocating quality of service is employed. Such techniques are applied to the situations involving relatively long term allocation of the quality of service. Using this technique, the service provider obtains a “resource pool” from the network management system. The service provider pays the network provider a predetermined fee, and application program interface calls, for example, to reserve the resource pool go to the network management system of the network provider. The service level agreement is then interchanged among the network providers, with the relatively longer term quality of service being provided. In this first phase of allocation, the load on the management system is a factor of the number of services/applications multiplied by the frequency of requests multiplied by the number of nodes.

The second phase for allocating quality of service is that within this longer term overall allowance of the resource pool, the service provider provides short term allocations of quality of service. Unlike conventional approaches, API calls to reserve or release quality of service resources on each router do not go to the network management system, but instead are determined locally, allowing the quality of service guaranteed path to be established quickly. In this second phase of allocation, the load on the management system is a factor of the number of services/applications multiplied by the frequency of requests. The number of nodes is not a factor, and thus the allocation of resources may be made on demand, rather than in advance as in conventional systems.

In the event the resource pool is completely consumed, but an API call is received to reserve additional service, the information from the API is sent to a quality of service control mechanism. Using this as a trigger, the long term, relatively stable, quality of service allocation can be reallocated. This trigger to reallocate can be established using any well known algorithm, but is typically set to occur when a predetermined portion of the resource pool is consumed, for example 90%. Preferably, in the API where both long term and short term resources are allocated, the path, class of service, and bandwidth are also specified.

In a preferred embodiment, a system according to this invention includes the capability of dynamically allocating resources to enable provision of different levels of service to different users of a network. Portions of the network include routers. The routers include at least one input port for receiving information from a source, and at least one output port for providing the information from the source to a destination. Each router further includes a mechanism for allocating quality of service in a relatively dynamic manner, for example, using a flow control table which stores entries. The entries in the flow control table specify the quality of service and can be changed locally, without need of requests to or approvals from the network management system. The flow control table is based upon source addresses representative of the source of information arriving at the input port and destination addresses representative of the destinations to which the arriving information to be sent from the output port. The entries include priority information for each address, and this priority information is capable of including different priorities. In response to the system, information arriving at the router from the source is forwarded to the destination with a priority based upon the priority information in the flow control table corresponding to the source and destination address of the data.

### BRIEF DESCRIPTION OF THE DRAWINGS

FIG. 1 is a schematic representation of a typical network video delivery service system employing routers;

FIG. 2 is a block diagram illustrating a network configuration in detail;

FIG. 3 is an example of a flow control table;

FIG. 4 illustrates the controller software;

FIG. 5 illustrates the structure of a resource pool;

FIG. 6 is a flow chart illustrating a method of handling a resource allocation request;

FIG. 7 is a flow chart illustrating a method of controlling resource allocation; and

FIG. 8 is a flow chart of a method for NMS communication.

### DESCRIPTION OF THE SPECIFIC EMBODIMENTS

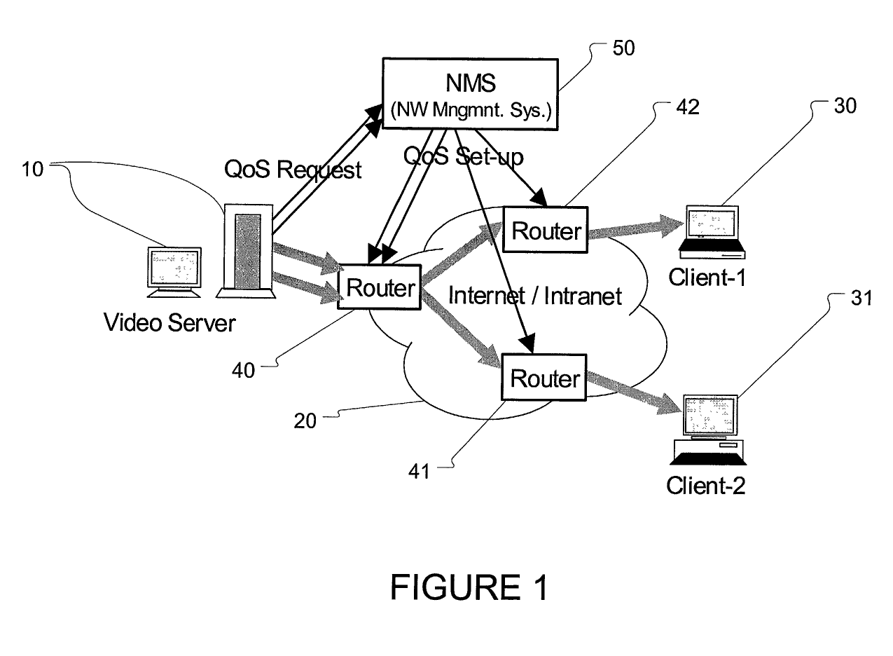

FIG. 1 is a diagram illustrating a typical example of a network, and particularly the technique by which the quality of service on such a network can be controlled. In the system shown in FIG. 1, video programs are transmitted from a video server 10 over a network 20 to a variety of clients 30, 31. The network includes routers 40, 41 and 42 which are used to route the data received from the video server 10 through the network 20 and ultimately to the clients 30 and 31. Each client 30, 31 can start and end the video reception at that client's terminal at any time. Furthermore, the client has the capability of changing the “channel” which requires the video server 10 to transmit a different video stream over the network 20 with a different quality of service requirement. A network management system (NMS) controls each of the routers 40, 41 and 42 in response to quality of service requests received from video server 10. As will be described, our invention enables the quality of service settings for a network, such as the one depicted to be changed quickly, thus enabling the handling of higher volumes of data, even for short sessions.

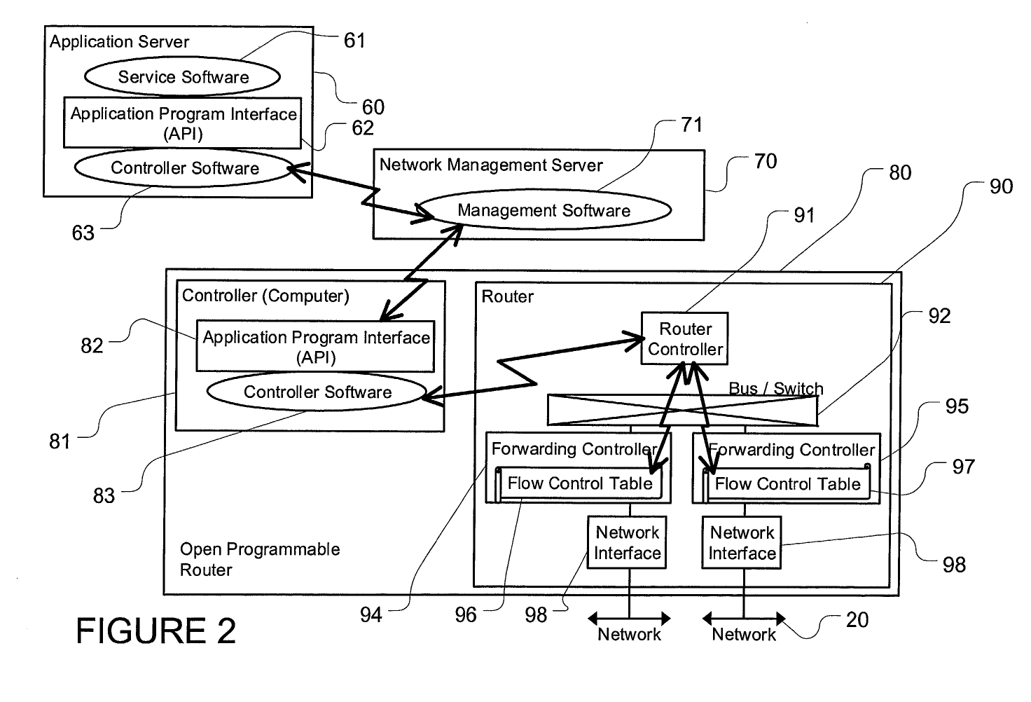

FIG. 2 is a block diagram illustrating a sample network configuration for implementation of our invention. As shown there, the system consists of an application server 60, a network management server 70, and an open programmable router 80. Application server 60 runs service software 61 which via an application program interface (API) 62 and controller software 63 provides control information to the network management server 70. Server 70 operates under the control of management software 71. The network management server 70, in turn, controls the open programmable router 80. This is achieved by transmission of data from server 70 to controller 81 within router 80. Controller 81, typically a computer, also includes controller software 83 which is accessed via an application program interface 82. Controller software 83, in turn, controls router 90 by sending information to router controller 91. Router controller 91 operates through a bus or switch 92 to provide control information to controllers 94 and 95. Each of controllers 94 and 95 includes a flow control table 96, 97 whose function is described below. The controllers 94 and 95 are connected through network interfaces 98 to the network 20.

In operation, packets arriving on network 20 are connected through the network interfaces 98 to the controllers 94 and 95. These controllers, using header information from the packets, perform appropriate operations on the packets, including removal of the header information and replacement of that information with new address information, or other well know operations.

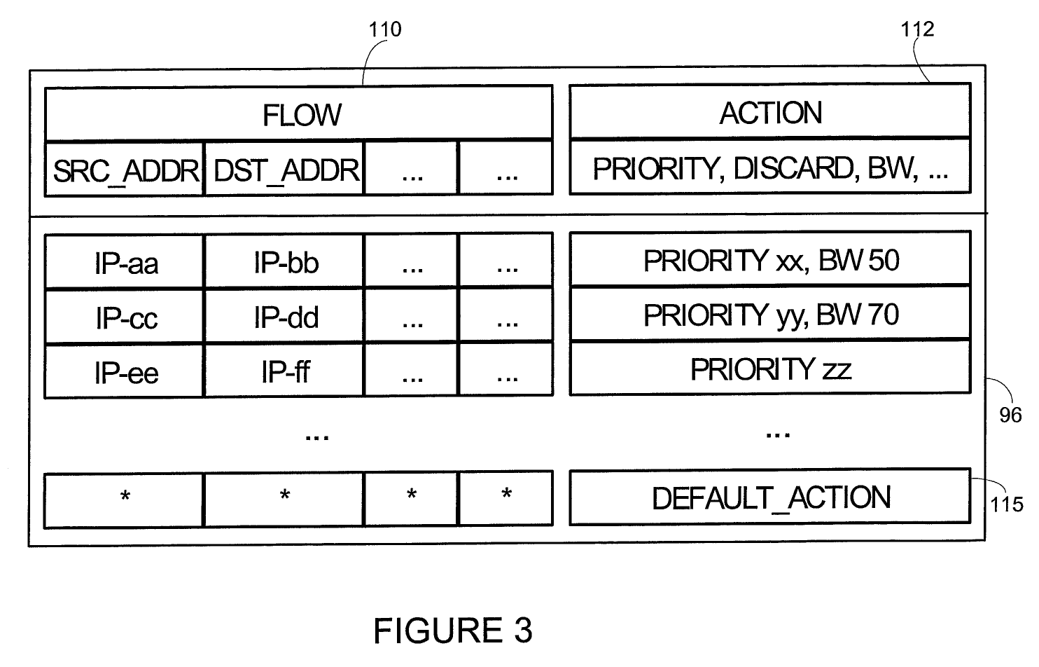

The forwarding controllers 94 and 95 control the packets in part based upon the settings of the flow control table 96 and 97. The flow control table is maintained by the router controller 91, which itself receives information from the controller 81. It should be understood that controller 81 can control more than a single router, and as is well known, each router can have many network interfaces for receiving and transmitting information to and from the network. As discussed below, the use of the APIs in the controller 81 allows application software to be executed elsewhere and easily communicated to the programmable router 80. The operation of the system shown in FIG. 2 is explained with respect to FIGS. 3-8.

FIG. 3 is a more detailed example of a flow control table, using table 96 as an example. When a packet arrives over network 20 to the network interface 98, the forwarding controller 94 searches through flow control table 96 to determine whether the header information for the incoming packet is registered in the table. This is done by matching the entries in the flow portion 110 of the table 96 with respective fields in the packet. For example, the flow 110 portion of table 96 includes columns for source address (SRC_ADDR) and destination address (DST_ADDR). Because the packet received at the router consists of header information and payload information, the flow portion of the table typically will be concerned only with the header information.

After checking the incoming packet against the flow table 110, an appropriate action, shown in the “Action” portion of the table 112, will be carried out. For example, incoming packets from source IP-cc which are to be sent to address IP-dd will be forwarded with a priority of “yy” and a bandwidth of at least 70. In other words, as long as the bandwidth of the flow stays under 70, the router will transmit the packets with priority ‘yy’. If the bandwidth exceeds 70, it will transmit with priority ‘yy’ for the first 70 of the bandwidth of 70, but without a guarantee for the excess portion. It may drop packets (randomly) to make the flow fit in the allowed bandwidth of 70, or it may send the 70 part with priority ‘yy’ and the rest in “Best Effort.” In a similar manner, packets from source IP-ee which are addressed to location IP-ff will be dispatched with priority zz at an unspecified bandwidth. Packets whose header information does not correspond to entries in the flow table will be handled in accordance with a default action, as illustrated by row 115. This default action is typically set by the longer term “static” allocation of quality of service, in other words phase 1 as described above. Actions in flow control table 96 can be modified by hardware, or software processing. In prior art systems, quality of service requests from the application server 60 went first to the network management system 70 and then to all of the routers residing on the requested path. Such requests include both allocation and release requests, changes in the amount of resources for already-allocated paths, and other similar control operations. In contrast herein, the flow control tables and dynamically allocable resource pool enable control of the quality of service requests, as is explained below.

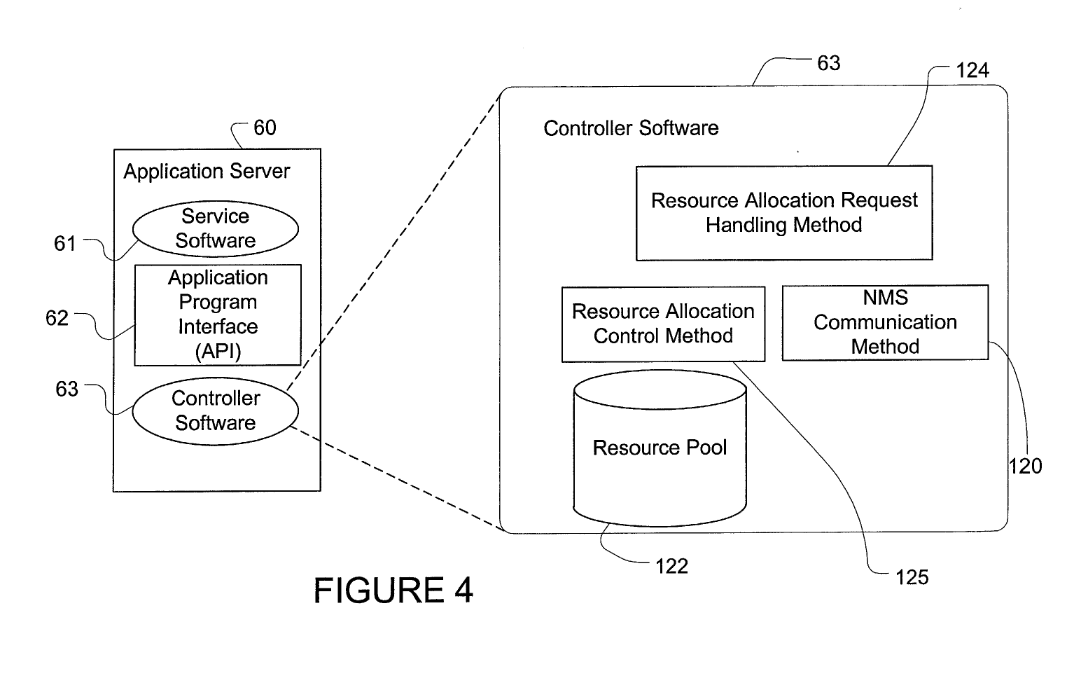

FIG. 4 illustrates in more detail the controller software which typically is residing on the application server 60, previously discussed with respect to FIG. 2. As shown in FIG. 4, the controller software 63 includes code 124 for handling resource allocation requests. It also includes code 125 for controlling resource allocations, and code 120 for communicating with the network management system. The code for each of the request handling method 124, the resource allocation control method 125 and the communication software 120 for communicating with the network management system will be described below.

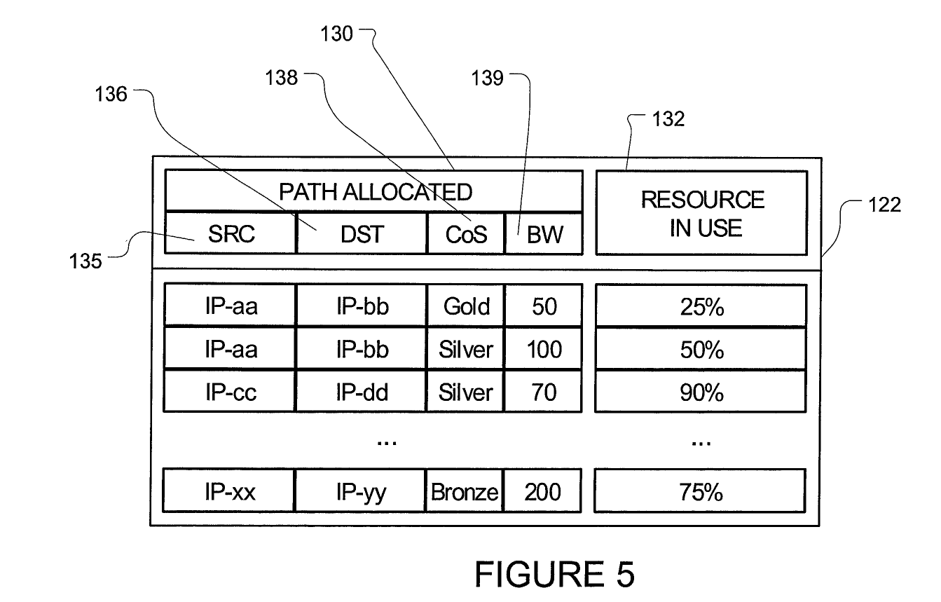

Controller software 63 also includes information about a resource pool 122. This is described in further detail with respect to FIG. 5, which illustrates one embodiment for the resource pool. Resource pool 122 consists essentially of a database that manages the amount of quality of service resources already allocated to a particular application, as well as the extent to which that resource is in use. As shown in FIG. 5, the resource pool includes a section related to the allocated path 130, and a section 132 which tracks the extent to which that resource is in use. For example, each entry in the resource pool database includes a source address 135, a destination address 136, an indication of the cost of that service 138, and an entry BW 139 which indicates the allocated bandwidth. The corresponding row in the use portion 132 of the database indicates the extent to which that resource is in use.

Although controller software 63 has been described as being located on application server 60, it may be situated elsewhere, and it may be controlling more than one application server. Using well known technology such as Common Object Request Broker Architecture (CORBA) the software can be distributed to any desired location.

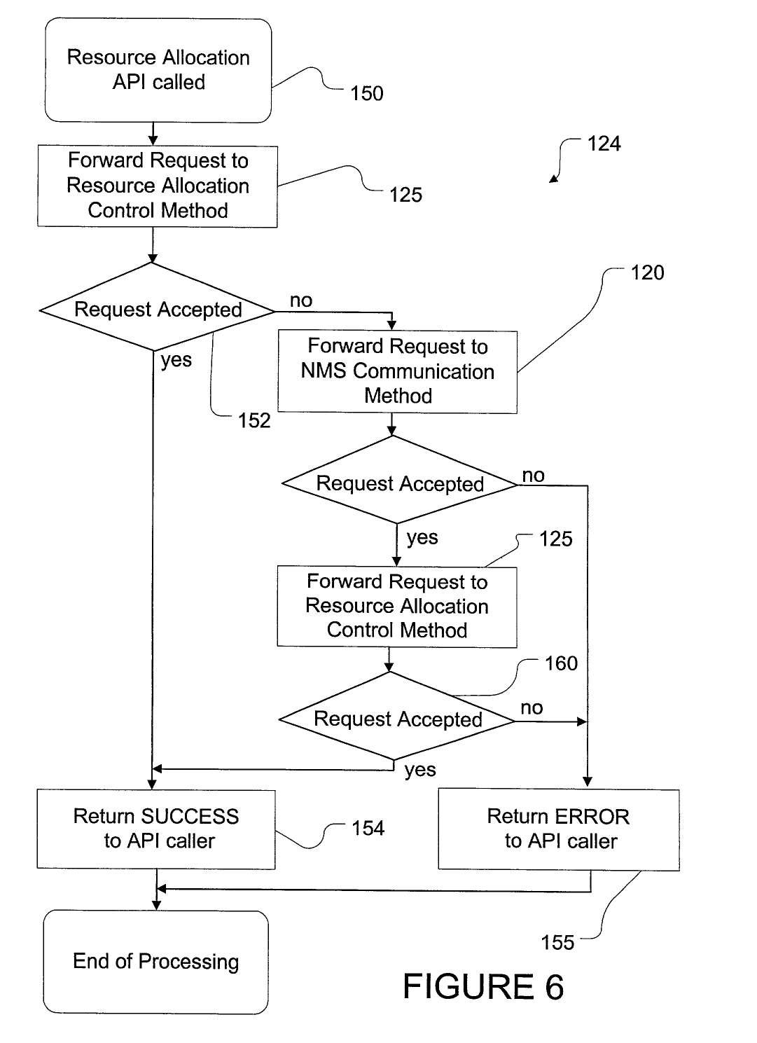

FIG. 6 is a flow chart. The flow chart in FIG. 6 illustrates the manner in which resource allocation requests are handled by the system herein. The steps illustrated in FIG. 6 are performed by controller software 63, preferably situated on application server 60 as illustrated by FIGS. 2 and 4. As shown in FIG. 6 the process begins with a call to the resource allocation API 150. This results in the request being forwarded to the resource allocation control method 125 which either accepts or declines the request at decision point 152. If the request is accepted, an appropriate message or return value 154 is returned to the system which called the API. On the other hand, if the request is declined, it is forwarded to the NMS communication method software 120 for a decision as to whether to accept that request. If that request is accepted, it is then forwarded to the resource allocation control method software 125. On the other hand, if it is declined an error message 155 is returned to the system calling the API. If control 125 accepts the request at decision point 160, then success is returned to the API caller as shown in block 154.

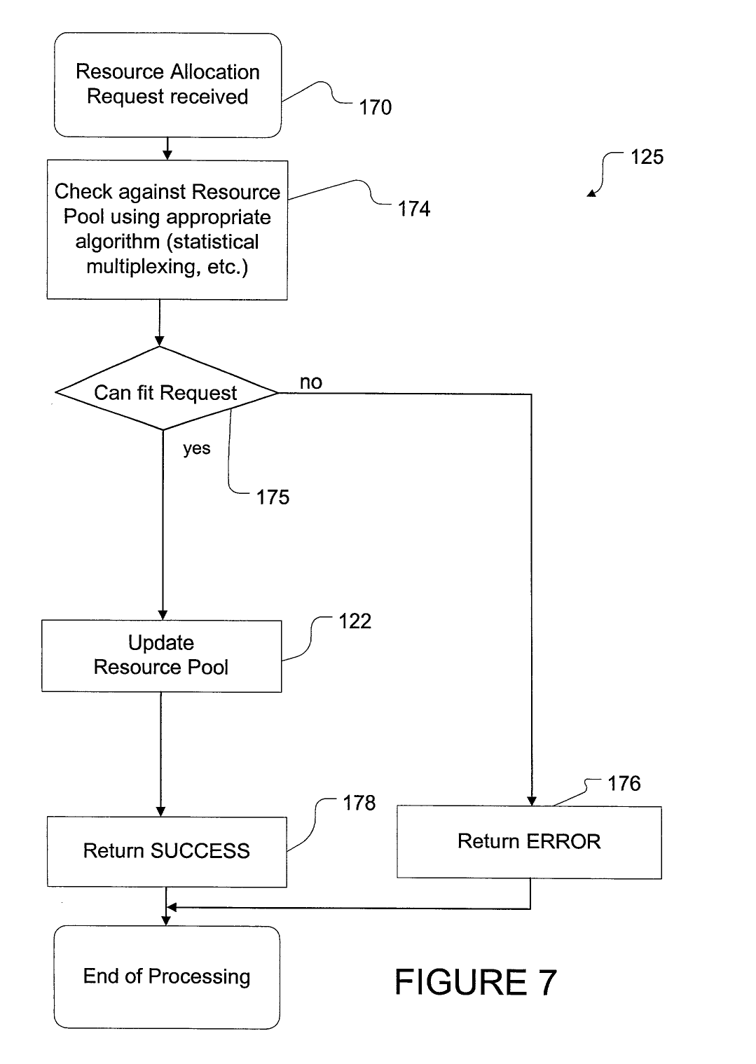

FIG. 7 is a flow chart illustrating the method 125 by which resource allocation control shown earlier in FIG. 6 is performed. This flow chart explains the method described generally in FIG. 4. As shown in FIG. 7, a request for resource allocation is received at step 170. Once the request is received, a check is made against the resource pool (shown in FIG. 5) to determine the availability of resources. This check 174 can use appropriate algorithms to determine the statistical likelihood of the availability of a particular path or other service criteria. If the request cannot be handled, an error message 176 is returned. On the other hand, if at step 175 the request can be accommodated, the resource pool 122 is updated and a successful message 178 is returned.

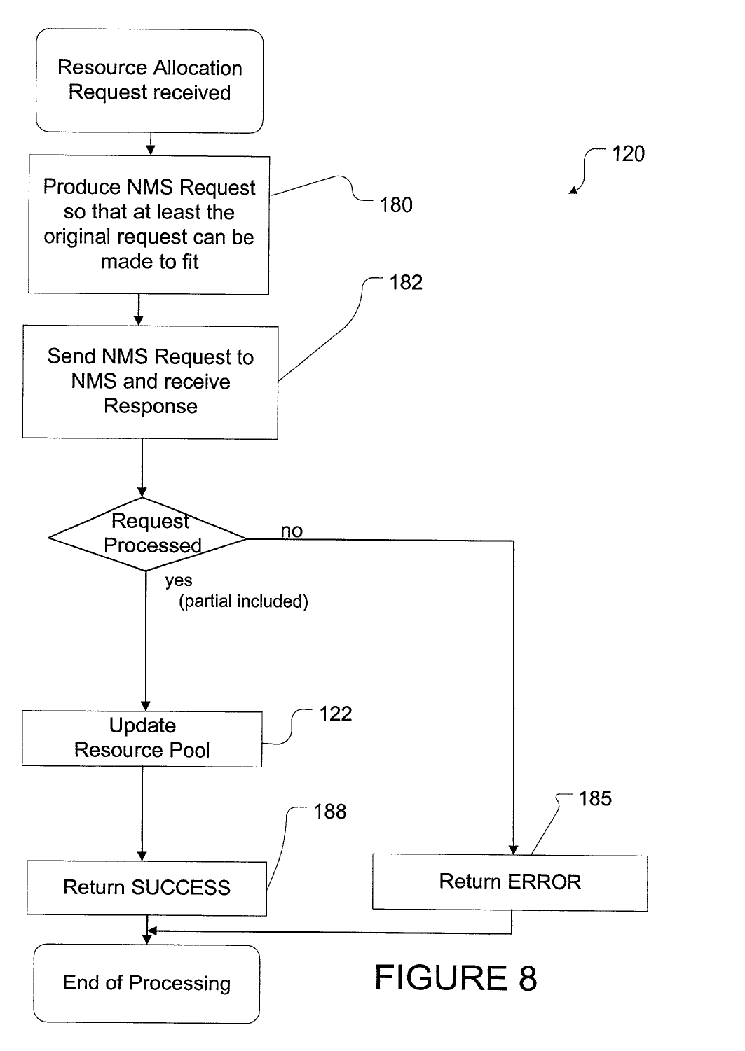

FIG. 8 is a flow chart of the NMS communication method 120 shown earlier in FIG. 6. This method illustrates the communications between the network management server and the request for allocation resources. When the request is received, an NMS request is generated at step 180 in a manner so that at least an initial or original request can be handled by the resource pool. The request is then sent to the network management server and a response is awaited at step 182. If the request is not processed, an error message 185 is returned. On the other hand, if a request is processed, including the situation in which the request is only partially able to be processed, the resource pool is updated at step 122, and a successful message 188 is returned.

Using the techniques described above, when an application requests a quality of service path to transmit its data, for example video, to a new client, the quality of service configuration process may be completed within the application server. This eliminates the overhead of making transactions between the application server and the network management system, including pricing for transactions between the service provider and the network provider. Furthermore, it avoids burdening the routers with flow table setup requests. Only when the quality of service request cannot be met using the resource pool does the request and related processing go out into the network.

Next, we describe the API used by the application server to request a particular quality of service setting. This is API 62 from server 60 shown in FIG. 2. For convenience of explanation, we divide the API into two different approaches—a long term approach and a short term approach. Long term requests for quality of service settings are reserved in the resource pool, while short term requests are obtained from the resource pool. Requests for long term APIs send control to the network management facility, which addresses those requests using pricing and other variables as parameters for determining long term allocations. In contrast, when short term requests are made for quality of service changes, the requests may include expected duration time as a parameter. When the request is made, control is terminated within the application server. If the request cannot be met, an error message is returned and an allocation with the different cost of service or bandwidth for the same path is considered. In this case, a parameter may have been supplied by the application server which specifies the minimum allowable quality of service as a parameter. If the requests cannot be met by the resource pool even under these alternate approaches, an error message is returned. The error indicates that the resource pool is fully consumed, or so close to fully consumed that the needed quality of service request cannot be satisfied. In this case the application program will call the long term API, and upon a successful long term resource allocation will recall the short term API.

With the use of separate API's depending upon the term, service providers may use the long term API's to enable the creation of virtual private networks and to accommodate server transactions with multiple clients within their own virtual network. In such systems the service provider will typically pay the network provider for the resources allocated for virtual network. Within the virtual network the service provider can use the resources by employing its own management scheme which is customized or optimized for the network traffic. The long term resources to be allocated can be decided by the service provider according to its own expectation or its projection of the needs of network resources to fill all of the requests from its users. This enables changing the quality of service reservations according to the time of day, for example increasing long term reservations during business hours and decreasing them for weekends. It also enables the service provider to reserver a combination of paths rather than in a single end to end manner, with the separate API's forming a network of their own.

Another approach for handling allocations of quality of service involving API's combines the long term and short term API's into a single API. In this case when the API is called if there is no appropriate resource pool allocated, the API call is provided to the network management facilities to obtain resources from the resource pool. The resource pool allocated at that time may not only be for the resource to fulfill the current request from the API, but may also result in the resource pool being made larger enabling fast responses to future requests. If the API is called when there is already an appropriate resource pool allocated, control is terminated within the application server.

The use of a single API for long term and short term quality of service control is more suitable for a single service, for example a fixed server and client, where the service requires dynamic changes and settings. Such an approach is usually more efficient where bandwidth requirements are changing, or the number of flows to constitute the service changes. With the single API, the long term resources allocated at the first call is determined by the system, not by the entity requesting the API. Thus, the single API scheme is usually more appropriate for control of end to end connections, compared to the use in virtual private networks. Of course, if a long term resource has been reserved and is not being used, it may be used for other traffic using the techniques of this invention, thereby enabling more efficient use of the network overall. When the management of long term paths is done by the service providers themselves, the service providers can use their own algorithms with respect to management with loads depending upon their own characteristics. In this manner the service providers can optimize a number of lows to fit in the long term path, thus minimizing network costs, yet delivering a certain amount of traffic to their customers as required. By allowing the service provider to access its own algorithm for fitting more traffic into a given type, network resources can be more efficiently utilized than at present.

In some embodiments it is also desirable to have an API to release already allocated resources from the resource pool. This also may be achieved using an automated release mechanism, for example, triggered by time duration of resource allocation. How much of the resources can be released will depend upon the policies established by the network administrator, and can be implemented using statistical techniques.

One of the main benefits of our invention is a reduction of the number of transactions within the network management system. Present network management systems are designed to handle and setup all of the service paths in a time which is on the order of weeks or days, and rarely on the basis of hours. Such systems as described above can be used to establish a virtual private network at a predetermined time lasting for a predetermined period, for example by advance reservations. This approach can be used for prescheduled telephone conferences, as opposed to “adhoc” requests, such as when using a telephone. Because the network management system is a centralized control, it is very difficult for the management system to handle an adhoc pattern of transactions, particularly when that pattern becomes large. Furthermore, once the request reaches the management system, it must send the commands to the network elements, for example routers and switches, to establish the quality of service resource reservation. Therefore, with the increase in the number of requests, there can be a burden in the processing power for network elements.

The growing use of the internet protocol in networking makes it more and more important that quality of service provisioned communications paths be established in a more dynamic matter as described above. As the number of adhoc sessions in contrast to prescheduled sessions increases, it is desirable to reduce the number of transactions between the service application and the network management system, and between the network management system and the network elements themselves. In the present invention the resource pool and the capability of an application to manage its quality of service needs within the pre-reserved pool enables great performance than previously possible. The pool, in effect a cache of resources, is managed closer to the user of the network.

The foregoing has been a description of a preferred embodiment of the invention. It will be appreciated that numerous variations may be made within the scope of the appended claims, for example, different or special APIs may be used to provide additional features enabling still for further improvements and control of the network.

What is claimed is:

1. A system for allocating resources to enable provision of different levels of service for different users of a network having nodes at which routers are placed to direct information along various paths, the system comprising:
a first allocation of resources at a node, the first allocation being made by a first management system external to the node that manages at least part of the network; and
a second allocation of resources at the node, the second allocation being made by a second management system having a limited capability compared to the first management system and usable by the node in accordance with priorities determined at the node.

2. A system as in claim 1 further comprising a flow control table at the node operating under control of the second management system for storing entries which each include:
source addresses representative of at least one source of information arriving at the input port;
destination addresses representative of at least one of the destinations to which the arriving information is to be sent from the output port;
priority information for each address consisting of a capability of at least two different priorities for controlling the forwarding of information arriving from the source to the destination; and
wherein with the priority information is changeable at the node without reference to the first management system.

3. A router system as in claim 2 wherein the router system includes a router for switching information and a controller coupled to the router for storing the flow control table and controlling the router in response thereto.

4. A router system as in claim 3 wherein the priority information includes default priority information used to control information which does not otherwise have an entry in the flow control table.

5. A system as in claim 3 wherein the router has a capacity and not all of the capability of the router is allocated by the controller.

6. A system as in claim 5 wherein the unallocated portion of the capacity is reserved for use as a virtual private network.

7. A system as in claim 6 wherein the controller manages the flow control table using two application program interfaces.

8. A system as in claim 7 wherein the applications program interfaces include a first one for managing default priority information for a longer term usage, and a second one for managing the remaining entries of the flow control table for a shorter term usage.

9. A system as in claim 8 wherein the first and second applications program interfaces are under control of a network management system.

10. A system as in claim 9 wherein the network management system is controlled by a network service provider.

11. A system as in claim 9 wherein the first applications program interface is controlled by a network service provider and the second applications program interface is controlled by a provider of the source of information.

12. A system as in claim 11 wherein the controller manages the flow control table using a single applications program interface.

13. A system as in claim 12 wherein the applications program interface manages default priority information for longer term usage and manages the remaining entries of the flow control table for shorter term usage.

14. In a system for dynamically allocating resources to enable provision of different levels of service for different users of a network having nodes at which routers are placed to direct information along various paths, a method comprising:
allocating a first level of service from a remote source;
allocating a second level of service from a local source, the second level of service using resources available from the first level of service;
receiving information at an input port from a source;
storing in a flow control table entries which include source addresses representative of a source of information arriving at the input port, destination addresses representative of a destination to which the arriving information is to be sent, and priority information for each source address, which priority information includes at least two different priorities; and
forwarding information arriving from the source to the destination address with a priority based upon the priority information in the flow control table.

15. A method as in claim 14 wherein the method further comprises using a controller coupled to the router to store the flow control table and controlling the router in response thereto.

16. A method as in claim 15 wherein the method further comprises using default priority information to control arriving information which does not otherwise have an entry in the flow control table.

17. A method as in claim 16 wherein the router has a capacity; and the method comprises using the controller to allocate less than all of the capacity of the router.

18. A method as in claim 17 wherein the method further comprises reserving unallocated capacity of the router for use as a virtual private network.

19. A method as in claim 18 wherein the method further comprises using applications program interfaces to allow the controller to manage the flow control table.

20. A method as in claim 19 wherein method further comprises using a first applications program interface to manage default priority information for longer term usage, and using a second applications program interface to manage remaining entries of the flow control table for shorter term usage.

21. A method as in claim 20 further comprising using a network management system to control the first and second applications program interfaces.

22. A method as in claim 21 further comprising using a network service provider to control the network management system.

23. A method as in claim 22 further comprising using a network service provider to control the first applications program interface and using a provider of the source of information to control the second applications program interface.

24. A method as in claim 23 further comprising using a single applications program interface to manage the flow control table

25. A method as in claim 24 further comprising using the applications program interface to manages default priority information for longer term usage and using the remaining entries of the flow control table to manage for shorter term usage.
